(19) United States
(12) Patent Application Publication
(10) Pub. No.: US 2025/0145062 A1
(43) Pub. Date: May 8, 2025

(54) CHILD RESTRAINT

(71) Applicant: Dorel Juvenile Group, Inc., Foxboro, MA (US)

(72) Inventors: Stephen B. OLTMAN, Hope, IN (US); Jonathan M. HOLTMAN, Brownsburg, IN (US); Timothy L. EDWARDS, Columbus, IN (US); Said S. NAKHLA, Daphne, AL (US)

(21) Appl. No.: 18/934,783

(22) Filed: Nov. 1, 2024

Related U.S. Application Data
(60) Provisional application No. 63/547,212, filed on Nov. 3, 2023.

(51) Int. Cl. B60N 2/26

(52) U.S. Cl. CPC B60N 2/265

(57) ABSTRACT

A child restraint includes a seat shell and a child-restraint harness coupled to the seat shell. The seat shell is formed to include a child-receiving space configured to hold a child for transportation in a vehicle. The child-restraint harness is fixed to the seat shell and is configured to secure the child to the seat shell within the child-receiving space. The child-restraint harness includes a plurality of harness straps coupled to the seat shell, a pair of harness latches coupled to respective harness straps included in the plurality of harness straps, and a latch anchor coupled to a crotch strap included in the plurality of harness straps.

### PRIORITY CLAIM

This application claims priority under 35 U.S.C. § 119 (e) to U.S. Provisional Patent Application No. 63/547,212, filed Nov. 3, 2023, which is expressly incorporated by reference herein in its entirety.

### BACKGROUND

The present disclosure relates to a child safety device, and particularly to a child seat. More particularly, the present disclosure relates to a child car seat having a harness used to secure a child to the child car seat.

### SUMMARY

According to the present disclosure, a child restraint includes a seat shell and a child-restraint harness coupled to the seat shell. The seat shell is formed to include a child-receiving space configured to hold a child for transportation in a vehicle. The child-restraint harness is fixed to the seat shell and is configured to secure the child to the seat shell within the child-receiving space. The child-restraint harness includes a plurality of harness straps coupled to the seat shell, a pair of harness latches coupled to respective harness straps included in the plurality of harness straps, and a latch anchor coupled to a crotch strap included in the plurality of harness straps.

In illustrative embodiments, at least one of the harness straps includes a strip of webbing fixed to the seat shell and stitching extending through the strip of webbing to provide an energy-management section in the strip of webbing. The energy-management section is configured to change from an intact configuration to a disrupted configuration in response to a predetermined tensile force acting on the strip of webbing during an impact event. In the intact configuration, the stitching maintains one or more folds in the strip of webbing. In the disrupt configuration, the stitching comes apart from or breaks to reduce potential forces acting on the child during the impact event.

In illustrative embodiments, the stitching is sewn in a predetermined pattern on the strip of webbing and includes a first stitching region and a second stitching region spaced laterally from the first stitching region relative to a longitudinal axis of the strip of webbing. In some embodiments, the stitching further includes one or more additional stitching regions along the first and second stitching regions to provide multiple, variable energy-management zones in the energy-management section.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1A is a perspective view of a child restraint, in accordance with the present disclosure, including a seat shell and a child-restraint harness coupled to the seat shell and configured to restrain a child to the seat shell, with a portion of the seat shell cut away to show the child-restraint harness including a hip strap having an energy-management section formed into the hip strap and configured to break under load, as shown in FIG. 1C, to reduce potential forces acting on the child during an impact event;

FIG. 1B is an enlarged view of a portion of the hip strap from FIG. 1A showing the energy-management section in an intact configuration prior to the child-restraint harness being subjected to a tensile force above a predetermined amount;

FIG. 1C is an enlarged view of the portion of the hip strap from FIG. 1B showing the energy-management section in a disrupted configuration following an impact event that causes the child-restraint harness to experience a tensile force above the predetermined amount;

FIG. 2 is an enlarged view of one of the energy-management sections included in the child-restraint harness showing the energy-management section including a plurality of stitching regions to provide variable force-management zones during an impact event;

FIG. 3 is an exploded assembly view of the child restraint of FIG. 1 showing the child-restraint harness including a pair of hip straps, a pair of shoulder straps, and a crotch strap, and showing each strap included in the child-restraint harness including an energy-management section;

FIG. 4 is an enlarged view of one of the shoulder straps included in the child-restraint harness of FIG. 2 showing the shoulder strap including an energy-management section configured to break under load during an impact event to reduce a potential force experienced by the child;

FIG. 5 is an enlarged view of one of the hip straps included in the child-restraint harness of FIG. 2 showing the hip strap including the energy-management section configured to break under load during an impact event to reduce a potential force experienced by the child; and

FIG. 6 is an enlarged view of the crotch strap included in the child-restraint harness of FIG. 2 showing the crotch strap including an energy-management section configured to break under load during an impact event to reduce a potential force experienced by the child.

### DETAILED DESCRIPTION

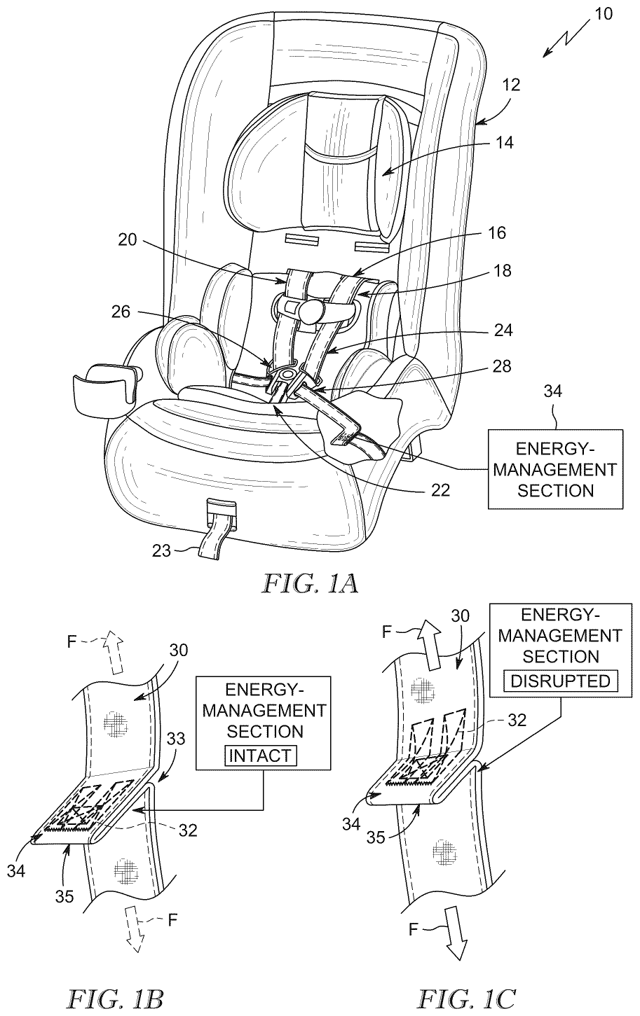

A child restraint 10 includes a seat shell 12 formed to include a child-receiving space 14 configured to hold a child for transportation in a vehicle as shown in FIG. 1. The child restraint 10 further includes a child-restraint harness 16 fixed to the seat shell 12 and configured to secure the child to the seat shell 12 within the child-receiving space 14.

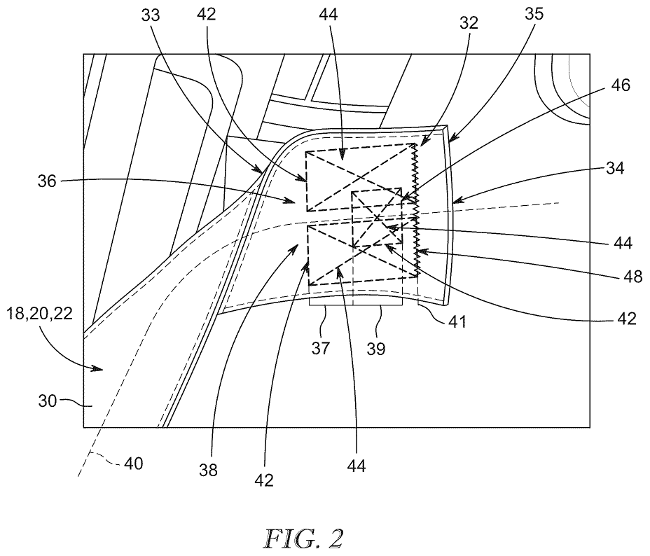

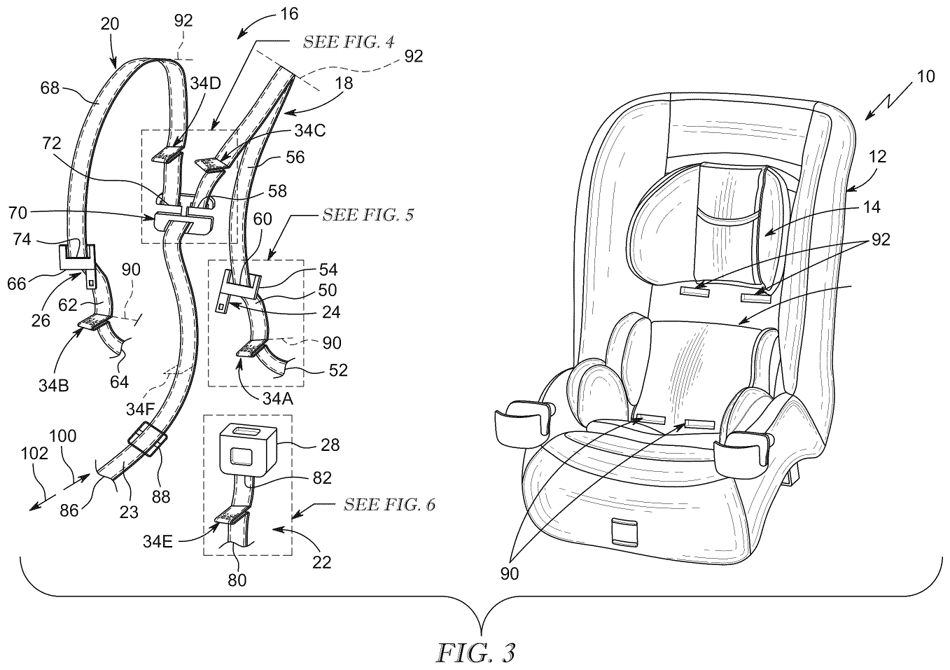

The child-restraint harness 16 includes a plurality of harness straps 18, 20, 22 coupled to the seat shell 12, a pair of harness latches 24, 26 coupled to respective harness straps 18, 20 included in the plurality of harness straps, and a latch anchor 28 coupled to a crotch strap 22 included in the plurality of harness straps. At least one of the harness straps 18, 20, 22 includes a strip of webbing 30 fixed to the seat shell 12 and stitching 32 extending through the strip of webbing 30 as shown in FIGS. 2 and 3. The strip of webbing 30 is folded prior to being stitched with the stitching 32 to provide an energy-management section 34 in the strip of webbing 30. The energy-management section 34 is configured to change from an intact configuration, as shown in FIG. 1B, to a disrupted or broken configuration, as shown in FIG. 1C, in response to the strip of webbing 30 experiencing a tensile force above one or more predetermined amounts or magnitudes.

The stitching 32 is configured to break or come undone from portions of the strip of webbing 30 under load to reduce potential forces acting on the child during an impact event. The stitching 32 is structured and placed selectively relative to the strip of webbing 30 to break at a predetermined rate and/or under a predetermined load or force F as suggested in FIGS. 1B and 1C. In the intact configuration, the stitching 32 (or other structure(s)) holds the folds of the strip 30 together. In the disrupted configuration, all or a portion of the stitching 32 is pulled away or broken from portions of the strip 30 in response to the tensile force F. This controls deceleration of the child during the impact event by increasing the amount of time the child decelerates against the child-restraint harness 16, thereby lessening a cumulative or potential force(s) experienced by the child. As a result of the disruptions or breaking of the energy-management zones, the energy-management section 34 has a first length in the intact configuration and a second length, less than the first length, in the disrupted configuration.

In the illustrative embodiment, the strip of webbing 30 is bi-folded to provide a single loop having an open-loop end 33 and a closed loop end 35 in the energy-management section 34. In other embodiments, the strip of webbing 30 may be tri-folded (or more folds) to provide multiple open-loop ends and closed-loop ends in the energy-management section 34. In some embodiments, the strip of webbing 30 may be a different material or structure that is not woven or webbed.

The stitching 32 is sewn in a predetermined pattern on the strip of webbing 30 and includes a first stitching region 36 and a second stitching region 38 spaced laterally from the first stitching region 36 relative to a longitudinal axis 40 of the strip of webbing 30 as shown in FIG. 2. Each stitching region 36, 38 includes an outer rectangle stitch 42 and an inner X-shaped stitch 44 located within the outer rectangle stitch 40.

The stitching 32 further includes a third stitching region 46 interconnecting the first and second stitching regions 36, 38 and arranged along the longitudinal axis 40. The third stitching region 46 includes an outer rectangle/square stitch 42 and an inner X-shaped stitch 44 within the outer rectangle stitch 42. The first and second stitching regions 36, 38 have a first length along the longitudinal axis 40 and the third stitching region 46 has a second length along the longitudinal axis 40 less than the first length. A width of each stitching region 36, 38, 46 is about the same (i.e. within 5%).

The stitching 32 further includes a base stitch 48 extending perpendicular to the longitudinal axis 40 and interconnecting the first and second stitching regions 36, 38. The base stitch 48 is spaced apart from the third stitching region 46. The base stitch 48 is formed with an end of the first and second stitching regions 36, 38 to reinforce the end of the first and second stitching regions 36, 38. In this way, the base stitch 48 and the end of the first and second stitching regions 36, 38 collectively have a greater thickness than the stitches forming other portions of the stitching regions 36, 38, 46.

In some embodiments, the energy-management section 34 can be formed in the strip of webbing 30 using components or elements other than or in addition to the stitching 32. In one example, the energy-management section 34 is formed by providing one or more adhesive sections on the strip of webbing 30 to provide an energy-management loop(s) in the strip of webbing 30. In other examples, other mechanical fastening structures, such as a hook-and-loop structure, one or more buttons, one or more rivets, and/or one or more heat seals can be used to provide the energy-management loop(s).

The stitching 32 and/or other structure used to form the energy-management section(s) 34 are configured to provide a plurality of variable energy-management zones 37, 39, 41 in the energy-management section 34. The first and second stitching regions 36, 38 are configured to provide a first energy-management zone 37 that extends from the open-loop end 33 of the energy-management section 34 to the third stitching region 46. The first, second and third stitching regions 36, 38, 46 are configured to provide a second energy-management zone 39 that extends along a length of the third stitching region 46 in the longitudinal direction 40 of the strip of webbing 30. An end of the first and second stitching regions 36, 38 opposite the open-loop end 35 and the base stitch 48 are configured to provide a third energy-management zone 41 along a plane that is perpendicular to the longitudinal direction 40 of the strip of webbing 30.

During an impact event, tensile forces F may be exerted on the strip of webbing 30 in opposite directions away from the energy-management section 34 as suggested in FIG. 1B. The first energy-management zone 37 is positioned closest to the open-loop end 33 of the energy management section 34 and is configured to disrupt or break first in response to a first predetermined tensile force as shown in FIG. 1C. The second energy-management zone 39 is configured to disrupt or break second in response to a second predetermined tensile force greater than the first predetermined tensile force. The third energy-management zone 41 is positioned closest to the closed-loop end 35 of the energy-management section 34 and is configured to disrupt or break third in response to a third predetermined tensile force greater than the second predetermined tensile force. In this way, the energy-management section 34 provides multiple zones for sequential disruption depending on the magnitude of tensile force experienced by the strip of webbing 30 to decelerate inertial movements of the child during the impact event and lessen the potential overall force that could be experienced by the child during the impact event.

The plurality of harness straps include a first strap section 18, a second strap section 20, a crotch strap 22, and an adjuster strap 23 as shown in FIG. 3. The first strap section 18, the second strap section 20, and the crotch strap 22 are all separate from one another but work in unison to restrain the child to the seat shell 12. Any one or combination of the straps included in the plurality of harness straps can have an energy-management section 34.

In the illustrative embodiment, the first strap section 18 includes a first hip strap 50 and a first shoulder strap 56 as shown in FIGS. 3-5. The first hip strap 50 includes a first end 52 fixed to the seat shell 12 and a second end 54 coupled to a first harness latch 24 included in the pair of harness latches. The first shoulder strap 56 is contiguous with the first hip strap 50 and has a first end 58 coupled to a splitter 70 and a second end 60 coupled to the first harness latch 24. The first harness latch 24 is slidable along the first strap section 18 and illustratively defines an end point for the first hip strap 50 and the first shoulder strap 56. One or both of the first hip strap 50 and the first shoulder strap 56 can be formed to include an energy-management section 34 between the ends thereof.

The second strap section 20 is formed similarly to the first strap section 18 and includes a second hip strap 62 and a second shoulder strap 68. The second hip strap 62 includes a first end 64 fixed to the seat shell 12 and a second end 66 coupled to a second harness latch 26 included in the pair of harness latches. The second shoulder strap 68 is contiguous with the second hip strap 62 and has a first end 72 coupled to the splitter 70 and a second end 74 coupled to the second harness latch 26. The second harness latch 26 is slidable along the second strap section 20 and illustratively defines an end point for the second hip strap 62 and the second shoulder strap 68. One or both of the second hip strap 62 and the second shoulder strap 68 can be formed to include an energy-management section 34 between the ends thereof.

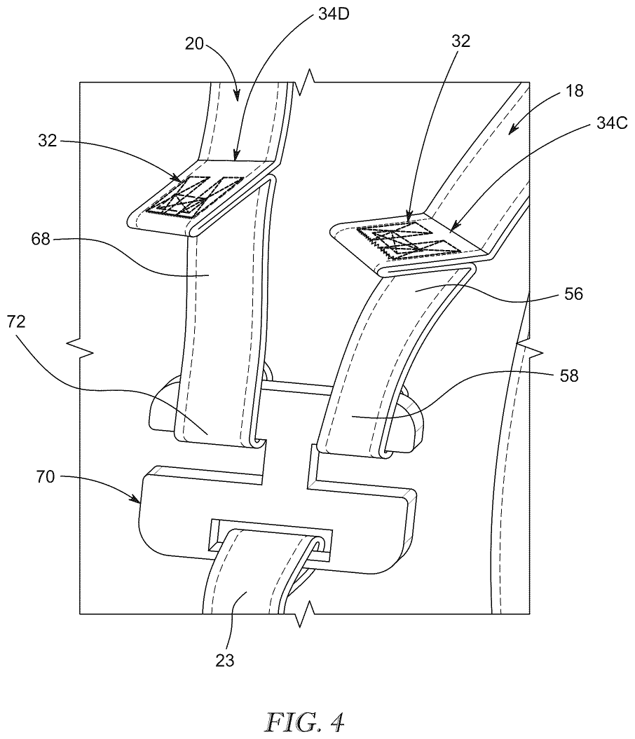

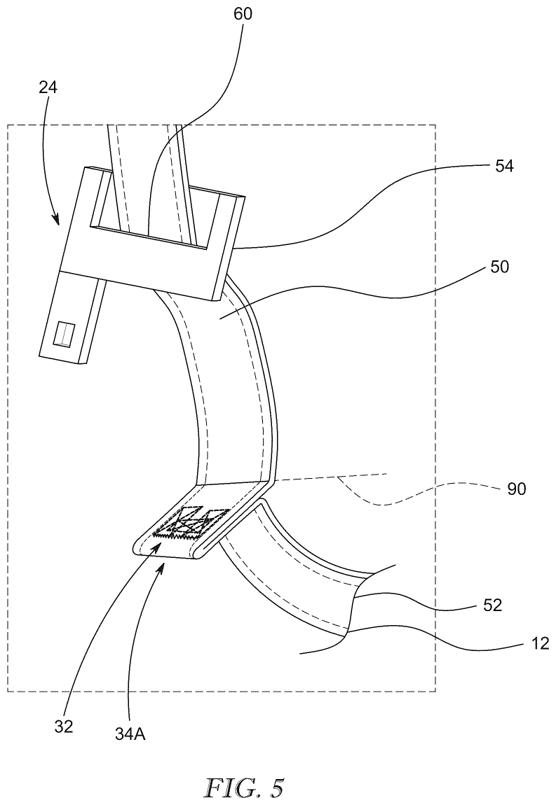

In the illustrative embodiment a first energy-management section 34A is located between the first end 52 of the first hip strap 50 and the first end 58 of the first shoulder strap 56 and a second energy-management section 34B is located between the first end 64 of the second hip strap 62 and the first end 72 of the second shoulder strap 68. In particular, the first energy-management section 34A is located between the first end 52 of the first hip strap 50 and the first harness latch 24 and the second energy management section 34B is located between the first end 64 of the second hip strap 62 and the second harness latch 26 as shown in FIGS. 3 and 5. In some embodiments, a third energy-management section 34C is located between the first end 58 of the first shoulder strap 56 and the first harness latch 24 and a fourth energy-management section 34D is located between the first end 72 of the second shoulder strap 68 and the second harness latch 26 as shown in FIGS. 3 and 4.

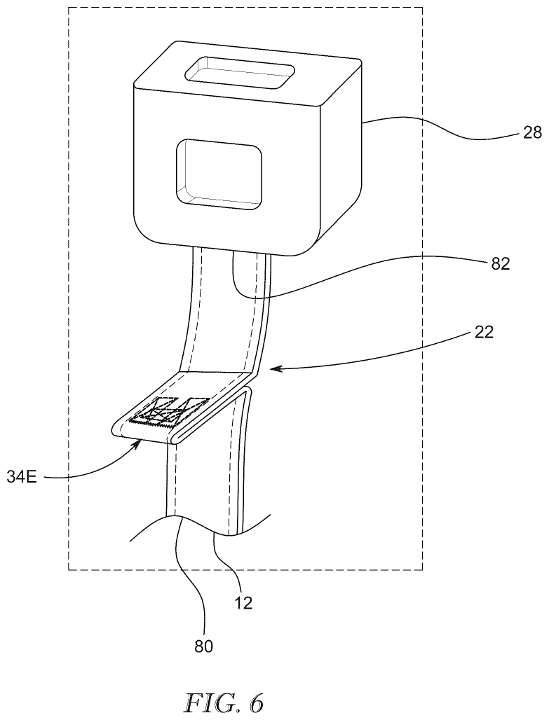

The crotch strap 22 is fixed to the seat shell 12 and spaced laterally between the first end 52 of the first hip strap 50 and the first end 64 of the second hip strap 62. The crotch strap 22 has a first end 80 fixed to the seat shell 12 and a second end 82 coupled to the latch anchor 28. In some embodiments a fifth energy-management section 34E is formed in the crotch strap 22 and located between the first and second ends 80, 82 of the crotch strap 22 as shown in FIGS. 3 and 6.

The adjuster strap 23 is configured to be adjusted relative to the seat shell 12 to tighten or loosen the first and second strap sections 18, 20. The adjuster strap 23 has a first end 84 coupled to the splitter 70 and a second end 86 spaced apart from the first end 84. The adjuster strap 23 is coupled to an adjuster clamp 88 that is fixed to the seat shell 12. The adjuster clamp 88 is configured to selectively engage the adjuster strap 23 to block movement of the adjuster strap 23 in at least a loosening direction 100. The adjuster strap 23 is configured to be pulled in a tightening direction 102 away from the adjuster clamp 88 to tighten the first and second strap sections 18, 20 around a child and in unison with one another. A sixth energy-management section 34F can be formed in the adjuster strap 23 and located between the adjuster clamp 88 and the first end 84 of the adjuster strap 23 as shown in FIG. 3.

The seat shell 12 is formed to include strap slots 90, 92 that allow passage of the strap sections 18, 20 therethrough such that portions of the strap sections 18, 20 are arranged in the child receiving space 14 and on an opposite side 15 (i.e. a rear side or interior) of the seat shell opposite from the child-receiving space 14. The energy-management sections 34A and 34B may be located in the child-receiving space 14 or on the opposite side 15 of the seat shell 12. If the energy-management sections 34A, 34B are located in the child-receiving space 14, they are preferably positioned as close to the slots 90 as possible so as not to engage and interfere with the child.

The energy-management sections 34C, 34D are located on the opposite side 15 of the seat shell 12 from the child-receiving space 14 so as not to engage or interfere with the child. The adjuster strap 23 has a maximum tightening length when the adjuster strap 23 is pulled through the adjuster clamp 88 a maximum amount. A distance between the slots 92 and the energy-management sections 34C, 34D does not exceed the maximum tightening length so that the energy-management sections 34C, 34D remain on the opposite side 15 of the seat shell 12 at all times and do not interfere with tightening or loosening of the straps 18, 20.

In some embodiments, an energy-management section 34 is formed on more than one straps included in the plurality of straps (i.e. both hip straps and/or both shoulder straps, and/or the crotch strap and/or the adjuster strap). In some embodiments, an energy-management section 34 is formed on every strap included in the plurality of straps.

1. A child restraint comprising
a seat shell formed to include a child-receiving space configured to hold a child for transportation in a vehicle, and
a child-restraint harness fixed to the seat shell and configured to secure the child to the seat shell within the child-receiving space, the child-restraint harness including a plurality of harness straps coupled to the seat shell, a pair of harness latches coupled to respective harness straps included in the plurality of harness straps, and a latch anchor coupled to a crotch strap included in the plurality of harness straps,
wherein at least one of the harness straps includes a strip of webbing fixed to the seat shell and stitching extending through the strip of webbing to provide an energy-management section in the strip of webbing, and the energy-management section is configured to come apart under load to reduce potential forces acting on the child during an impact event.

2. The child restraint of claim 1, wherein the stitching is sewn in a predetermined pattern on the strip of webbing and includes a first stitching region and a second stitching region spaced laterally from the first stitching region relative to a longitudinal axis of the strip of webbing.

3. The child restraint of claim 2, wherein each stitching region includes an outer rectangle stitch and an inner X-shaped stitch located within the outer rectangle stitch.

4. The child restraint of claim 2, wherein the stitching further includes a third stitching region interconnecting the first and second stitching regions and located on the longitudinal axis of the strip of webbing.

5. The child restraint of claim 4, wherein the first and second stitching regions have a first end located at an open-loop end of the energy-management section and a second end located at a closed-loop end of the energy-management section, and wherein the third stitching region is located closer to the second end than the first end.

6. The child restraint of claim 4, wherein the first and second stitching regions have a first length along the longitudinal axis and the third stitching region has a second length along the longitudinal axis less than the first length.

7. The child restraint of claim 4, wherein the stitching further includes a base stitch extending perpendicular to the longitudinal axis and interconnecting the first and second stitching regions.

8. The child restraint of claim 7, wherein the base stitch is spaced apart from the third stitching region and is coupled to an end of the first and second stitching regions to reinforce the end of the first and second stitching regions.

9. The child restraint of claim 1, wherein the energy-management section has a first energy-management length prior to the impact event and a second energy-management length less than the first energy-management length after the impact event.

10. The child restraint of claim 9, wherein the at least one strap coupled to the energy-management section has a first strap length prior to the impact event and a second strap length greater than the first strap length after the impact event.

11. The child restraint of claim 1, wherein the stitching is sewn in a predetermined pattern on the strip of webbing and includes a first energy management zone configured to break in response to a first predetermined tensile force acting on the at least one strap and a second energy-management zone configured to break in response to a second predetermined tensile force greater than the first predetermined tensile force acting on the at least one strap.

12. The child restraint of claim 1, wherein the energy-management section is formed on a hip strap included in the plurality of straps, the hip strap having a first end fixed to the seat shell and an opposite second end coupled to a harness latch included in the pair of harness latches, and wherein the energy-management section is located between the first end and the second end.

13. The child restraint of claim 12, wherein the energy-management section is located in the child-receiving space.

14. The child restraint of claim 1, wherein the plurality of straps include a first strap section, a second strap section, the crotch strap, and an adjuster strap, and wherein the energy-management section is a first energy management section formed in the first strap section and the child-restraint harness further includes a second energy-management section formed in the second strap section.

15. The child restraint of claim 14, wherein the first strap section includes (i) a first hip strap having a first end fixed to the seat shell and a second end coupled to a first harness latch included in the pair of harness latches and (ii) a first shoulder strap contiguous with the first hip strap and having a first end coupled to a splitter and a second end coupled to the first harness latch, and
wherein the second strap section includes (i) a second hip strap having a first end fixed to the seat shell and a second end coupled to a second harness latch included in the pair of harness latches and (ii) a second shoulder strap contiguous with the second hip strap and having a first end coupled to the splitter and a second end coupled to the second harness latch, and
wherein the first energy-management section is located between the first end of the first hip strap and the first end of the first shoulder strap, and the second energy-management section located between the first end of the second hip strap and the first end of the second shoulder strap.

16. The child restraint of claim 15, wherein the crotch strap is fixed to the seat shell and spaced laterally between the first end of the first hip strap and the first end of the second hip strap, and the adjuster strap has a first end coupled to the splitter and a second end coupled to an adjuster clamp.

17. The child restraint of claim 1, wherein the energy-management section is formed on a shoulder strap included in the plurality of straps, the shoulder strap having a first end coupled to a splitter and a second end coupled to a harness latch included in the pair of harness latches, and wherein the energy management section is located between the first and the second end and outside of the child-receiving space.

18. The child restraint of claim 1, wherein the energy-management section is formed on the crotch strap, the crotch strap having a first end coupled to the seat shell and a second end coupled to the latch anchor, and wherein the energy-management section is located between the first and second ends.

19. A child restraint comprising
a seat shell formed to include a child-receiving space configured to hold a child for transportation in a vehicle, and
a child-restraint harness fixed to the seat shell and configured to secure the child to the seat shell within the child-receiving space, the child-restraint harness including a plurality of harness straps coupled to the seat shell, a pair of harness latches coupled to respective harness straps included in the plurality of harness straps, and a latch anchor coupled to the seat shell and configured to engage selectively with the pair of harness latches,
wherein at least one of the harness straps includes a strip fixed to the seat shell and an energy-management section formed in the strip, and the energy-management section is configured to come apart under load to reduce potential forces acting on the child during an impact event.

20. The child restraint of claim 19, wherein the energy-management section includes a predetermined pattern on the strip and has a first energy management zone configured to break in response to a first predetermined tensile force acting on the strip and a second energy-management zone configured to break in response to a second predetermined tensile force greater than the first predetermined tensile force acting on the strip.
